(19) United States
(12) Patent Application Publication
(10) Pub. No.: US 2026/0205206 A1
(43) Pub. Date: Jul. 16, 2026

(54) Dynamic Spectral Equalization in Ladder Protected Optical Networks

(71) Applicant: Ciena Corporation, Hanover, MD (US)

(72) Inventors: Kevan Peter Jones, Ottawa (CA); Veronique Talon, Dollard-des-Ormeaux (CA); Mark R. Hinds, Ottawa (CA)

(73) Assignee: Ciena Corporation, Hanover, MD (US)

(21) Appl. No.: 19/015,931

(22) Filed: Jan. 10, 2025

(51) Int. Cl. H04B 10/67; H04B 10/2507

(52) U.S. Cl. CPC H04B 10/674; H04B 10/25073

(57) ABSTRACT

A dynamic equalization method is implemented in a downstream intermediate line amplifier (ILA) node that include an ILA and a trunk protection switch (TPS) connected to a plurality of paths, each forming a rung in a ladder protection scheme. The dynamic equalization method includes steps of detecting a switch between a first path and a second path of the plurality of paths; compensating for any loss difference between the first path and the second path; and equalizing any optical spectrum differences between the first path and the second path.

### FIELD OF THE DISCLOSURE

The present disclosure relates generally to optical networking. More particularly, the present disclosure relates to systems and methods for dynamic spectral equalization in ladder protected optical networks.

### BACKGROUND OF THE DISCLOSURE

Optical protection switching, where traffic is automatically redirected from a failed or impaired optical path to a backup path, is implemented in optical networks to bolster their resilience and maintain uninterrupted services. In complex, multi-span networks—with multiple fiber segments that connect various nodes—there is a growing need to withstand multiple simultaneous span failures. This heightened need for robustness has led to the deployment of “ladder” protection strategies. Ladder protection involves arranging redundant optical paths in a ladder-like configuration, ensuring that if one span fails, traffic can be rerouted through an alternate “rung” of the ladder which is a different, diverse span. In doing so, networks gain significant improvements in survivability and overall stability.

However, the added resilience that ladder protection provides can introduce operational challenges. As the number of potential paths increases, so do the permutations and combinations of routes that signals may need to take. This complexity often results in higher equalization penalties—an effect related to the adjustments in power levels, gain, and other signal parameters required to maintain consistent performance across diverse and changing paths. These penalties, in turn, reduce the available link budget (the margin ensuring acceptable signal quality over distance) and thereby diminish the network's effective capacity. Consequently, while ladder protection substantially enhances robustness against multiple failures, it introduces significant equalization challenges since not all spans (on the rungs) have the same length, loss, spectral profile, or other key transmission characteristics.

### BRIEF SUMMARY OF THE DISCLOSURE

The present disclosure relates to systems and methods for dynamic spectral equalization in ladder protected optical networks. The present disclosure provides a method for implementing protection switching with dynamic spectral equalization, ensuring that while ladder protection significantly enhances network resilience by utilizing multiple redundant paths, it does not compromise signal integrity or overall capacity. Instead of facing increasing equalization penalties as traffic is rerouted across spans of varying lengths, losses, and spectral characteristics, this method continuously monitors and adjusts the spectral profiles to maintain a stable and uniform signal performance. As a result, networks can preserve maximum capacity even under changing path conditions. Furthermore, the present disclosure presents multiple approaches for realizing this dynamic spectral equalization—ranging from fully automated, real-time adaptive solutions to more static, preconfigured schemes—offering a spectrum of deployment complexities, costs, and operational characteristics. These options empower network operators to tailor the solution to their specific infrastructure, performance goals, and scalability requirements.

In an embodiment, a downstream intermediate line amplifier (ILA) node includes an ILA and a trunk protection switch (TPS) connected to a plurality of paths, each forming a rung in a ladder protection scheme; and a controller configured to detect a switch between a first path and a second path of the plurality of paths, cause compensation for any loss difference between the first path and the second path, and cause equalization of any optical spectrum differences between the first path and the second path. The compensation can be via a variable optical attenuator (VOA) or the TPS. The equalization can be via an adjustable spectral equalizer at the ILA. In an embodiment, the equalization can be performed by switching settings of the adjustable spectral equalizer from settings for the first path to settings for the second path, such that the ILA is pre-calibrated with the settings for both the first path and the second path. In another embodiment, the equalization can be performed by monitoring a first output at a head-end amplifier adjacent to the ILA on a fiber span and monitoring a second output power, and adjusting the adjustable spectral equalizer based on the first output and the second output. In a further embodiment, the equalization can be performed by switching settings of the adjustable spectral equalizer from settings for the first path to settings for the second path, such that the ILA is pre-calibrated with the settings for both the first path and the second path, monitoring a first output at a head-end amplifier adjacent to the ILA on a fiber span and monitoring a second output power, and adjusting the adjustable spectral equalizer based on the first output and the second output to equalize residual errors from the switching settings. The ladder protection scheme can include the plurality of paths providing fiber diversity without equipment protection. The equalization of any optical spectrum differences is synchronized with the switch, causing the equalization before a second failure in the ladder protection scheme.

In another embodiment, a dynamic equalization method is implemented in a downstream intermediate line amplifier (ILA) node including an ILA and a trunk protection switch (TPS) connected to a plurality of paths, each forming a rung in a ladder protection scheme. The dynamic equalization method includes steps of detecting a switch between a first path and a second path of the plurality of paths; compensating for any loss difference between the first path and the second path; and equalizing any optical spectrum differences between the first path and the second path. The compensating can be via a variable optical attenuator (VOA) or the TPS. The equalizing can be via an adjustable spectral equalizer at the ILA. In an embodiment, the equalizing can be performed by switching settings of the adjustable spectral equalizer from settings for the first path to settings for the second path, such that the ILA is pre-calibrated with the settings for both the first path and the second path. In another embodiment, the equalizing can be performed by monitoring a first output at a head-end amplifier adjacent to the ILA on a fiber span and monitoring a second output power, and adjusting the adjustable spectral equalizer based on the first output and the second output. In a further embodiment, the equalizing can be performed by switching settings of the adjustable spectral equalizer from settings for the first path to settings for the second path, such that the ILA is pre-calibrated with the settings for both the first path and the second path; monitoring a first output at a head-end amplifier adjacent to the ILA on a fiber span and monitoring a second output power, and adjusting the adjustable spectral equalizer based on the first output and the second output to equalize residual errors from the switching settings. The ladder protection scheme includes the plurality of paths providing fiber diversity without equipment protection.

In a further embodiment, a ladder optical network includes a first terminal node and a second terminal node; one or more intermediate line amplifier (ILA) nodes interconnecting the first terminal node and the second terminal node, using a ladder protection scheme, wherein each of the one or more ILA nodes includes an ILA and two protection switches (TPSs) on either side of the ILA, each TPS of the TPSs connect connected to a plurality of paths, each forming a rung in a ladder protection scheme, and wherein each of the one or more ILA nodes is configured to detect a switch between a first path and a second path of the plurality of paths, compensate for any loss difference between the first path and the second path, and equalize any optical spectrum differences between the first path and the second path. The loss can be compensated via a variable optical attenuator (VOA) or the TPS. The optical spectrum can be equalized via an adjustable spectral equalizer at the ILA. The optical spectrum can be equalized by switching settings of the adjustable spectral equalizer from settings for the first path to settings for the second path, such that the ILA is pre-calibrated with the settings for both the first path and the second path. The optical spectrum can be equalized by monitoring a first output at a head-end amplifier adjacent to the ILA on a fiber span and monitoring a second output power, and adjusting the adjustable spectral equalizer based on the first output and the second output.

### BRIEF DESCRIPTION OF THE DRAWINGS

The present disclosure is detailed through various drawings, where like components or steps are indicated by identical reference numbers for clarity and consistency.

FIGS. 1 and 2 illustrate network diagrams of optical networks with 1+1 optical protection (FIG. 1) and with ladder protection (FIG. 2) for explaining ladder protection.

FIG. 3 illustrates a network diagram of the Method for a calibrated system approach in the ladder optical network.

FIG. 4 illustrates a network diagram of the Method for a controlled system approach in the ladder optical network.

FIG. 5 illustrates a network diagram of the Method for a hybrid calibration and control approach.

FIG. 6 illustrates a flowchart of a dynamic equalization method in the ladder optical network.

### DETAILED DESCRIPTION OF THE DISCLOSURE

By automatically initiating a spectral re-equalization process immediately after a protection switch event, the network can rapidly restore transmission conditions before another failure occurs elsewhere in the ladder configuration. This prompt response ensures that variations in span length, loss, and spectral properties introduced by the new protection route are swiftly compensated, thereby minimizing any detrimental impact on the link budget. As a result, the network experiences fewer penalties associated with unequalized paths, allowing for more flexible concatenation of protection sections within the ladder without requiring excessive margin. By combining fast protection switching with a nearly as rapid—though slightly delayed—spectral re-optimization, the system effectively recovers performance before the next failure emerges. This reduced reliance on large link budgets to accommodate unpredictable changes in signal quality translates into the ability to support more protection sections with lower costs.

### Optical 1+1 and Ladder Protection

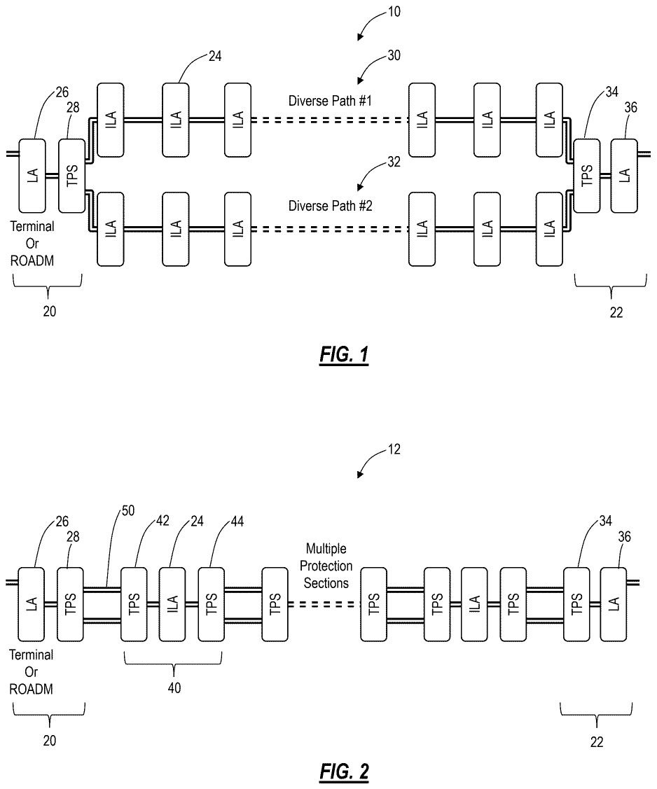

FIGS. 1 and 2 illustrate network diagrams of optical networks 10, 12 with 1+1 optical protection (FIG. 1) and with ladder protection (FIG. 2) for explaining ladder protection. Of course, those skilled in the art will appreciate these are merely examples for illustration purposes; other embodiments are also contemplated. Also, FIGS. 1 and 2 omit various components for ease of illustration; those skilled in the art will appreciate a practical implementation can include other components. That is, the focus on FIGS. 1 and 2 is to illustrate optical 1+1 protection (FIG. 1) in comparison with ladder protection (FIG. 2). The optical network 10 includes terminal nodes 20, 22 interconnected by various intermediate line amplifier (ILA) nodes 24. This is an optical multiplex section (OMS) or simply an optical section. The terminal nodes 20, 22 are also referred to as reconfigurable optical add/drop multiplexers (ROADM) and include other components (e.g., modems, multiplexers/demultiplexers, wavelength selective switches (WSSs), etc.) (not shown). Note, while referred to herein as “intermediate line amplifier,” the term ILA can also refer to an in-line amplifier, which is the same device.

For the optical 1+1 protection, there is a post amplifier 26 at the terminal node 20 which connects to a trunk protection switch (TPS) 28 which is configured to split the optical signals from the post amplifier 26 in two, i.e., two copies for transmission on diverse paths 30, 32. At the terminal node 22, there is another TPS 34 which receives the two copies from the diverse paths 30, 32, and provides a single copy to a pre amplifier 36. For the TPS 28, at the transmitting end, an optical splitter serves as the first key component, taking the input optical signal and creating two identical copies that are sent down the diverse paths 30, 32 the working and protection fibers. This passive optical component typically employs a 50:50 splitting ratio to ensure equal signal distribution. For the TPS 34, at the receiving end, an optical switch acts as the heart of the protection system. This 2×1 switch selects between the working and protection paths, featuring fast switching times in the millisecond range, low insertion loss, high extinction ratio, and support for bi-directional transmission.

Working alongside the switch is a comprehensive monitoring system that can include optical taps and photodetectors for power level monitoring, signal quality monitors for degradation detection, and control logic to determine protection switching triggers. The control unit manages the entire protection switching process by processing inputs from the monitoring system, implementing switching algorithms, and controlling the optical switch. It handles both automatic and manual protection switching while maintaining switching states and history. Finally, a management interface allows for system configuration and monitoring, enabling operators to set switch criteria, configure protection groups, establish alarm thresholds, monitor performance, and generate status reports. These components work in concert to provide reliable network protection and seamless switchover capabilities when network faults occur.

In FIG. 2, the optical network 12 similarly has the terminal nodes 20, 22 as in the optical network 10, with the same amplifiers 26, 36 and TPSs 28, 34. The difference is at intermediate line amplifier (ILA) nodes 40 in the ladder optical network 12. Here, there are TPSs 40, 42 that bookend each intermediate line amplifier 24 such that each span in the ladder optical network 12 includes fiber or span protection, i.e., against fiber cuts, but there are not two diverse paths 30, 32. Rather, there is a single path in terms of equipment, i.e., intermediate line amplifiers 24.

Ladder protection is a resiliency mechanism in the optical network 12 designed to provide fiber-level protection without ensuring equipment protection, differentiating it from 1+1 optical protection in the optical network 10. In ladder protection, the network is structured with multiple primary and backup paths arranged in a way that resembles a ladder, on each span 50. The “rungs” of the ladder provide alternative routes for traffic if a failure occurs in the primary fiber path. For example, the span 50 has two rungs which conceptually look like a ladder. Of course, the TPSs can provide more than 2×1 protection, e.g., N×1, allowing for N rungs. This approach ensures that traffic can be rerouted around fiber cuts or link failures within the network 12. However, ladder protection does not account for failures in the network equipment (e.g., amplifiers, transponders), as its primary focus is on maintaining signal integrity through redundant fiber paths.

In contrast, 1+1 optical protection provides both fiber and equipment protection. It involves transmitting the same signal simultaneously over two physically diverse paths, ensuring that if either a fiber or equipment failure occurs, the receiving end can instantly switch to the unaffected path. This makes 1+1 protection more robust but also more resource-intensive, as it requires duplicating both the fiber and the associated optical equipment. Ladder protection, being more fiber-focused, is a less resource-heavy solution tailored to scenarios where equipment-level redundancy is not critical.

Equalizing optical transmission signals along a single, stable route is a well-established practice, and optical protection switching is often deployed successfully in smaller or simpler networks. However, when extending these concepts to “ladder” networks—where multiple protection segments are cascaded one after another—the complexity increases dramatically. Each additional ladder span introduces unique fiber characteristics, such as different lengths, attenuation profiles, dispersion properties, and nonlinearities. When a protection switch occurs in one segment, it alters the signal's overall state and may require a re-optimization of equalization settings across the entire link. As multiple ladder spans potentially switch at different times and in different orders, the number of possible configurations grows exponentially, making it challenging to maintain stable, well-matched signal conditions end-to-end. Ultimately, the ability to concatenate many such protection sections is constrained by the available link budget margin, since each additional stage of switching and equalization adds uncertainty and complexity that must be accounted for, potentially pushing the system beyond its design limits.

### Dynamic Spectral Equalization in Ladder Networks

In optical networks employing protection switching, minimizing power transients during a switchover event is necessary for maintaining link stability and performance. One fundamental approach is to dynamically balance losses across different fiber paths within the protection switch. By incorporating variable optical attenuators (VOAs) on each path, it is possible to independently reduce the power levels until all paths reach a common loss baseline. This initial loss balancing ensures that no sudden, large transients occur when a path is selected, thus helping maintain signal stability. However, beyond simply matching power levels, it is also essential to consider the spectral characteristics of the system's transmission fiber. Nonlinearities within the fiber lead to a variable and power-dependent spectral response, causing certain wavelengths to experience different levels of attenuation or distortion. For optimal transmission, especially under conditions that demand maximum capacity, the optical spectrum must be carefully equalized in situ. This can be achieved once stable loading conditions are reached, either as a one-time calibration (discrete “calibration” mode) or through continuous adjustments (“control” mode).

In a multi-span “ladder” protection network, switching the signal to another fiber segment introduces a new set of spectral conditions due to differences in fiber length, composition, and nonlinearity. Even if the average loss has been balanced, these subtle variations in spectral shaping can degrade transmission performance. This disclosure addresses the challenge by proposing a dynamic method to re-equalize the spectral response whenever a protection switch occurs. By promptly updating the system's spectral profile after a failure, it is possible to restore performance to near-optimal levels without the need to preemptively allocate a large link budget margin for multiple switching events. This approach allows the network to maintain maximum transmission capacity, even after multiple fiber path failures and subsequent switches.

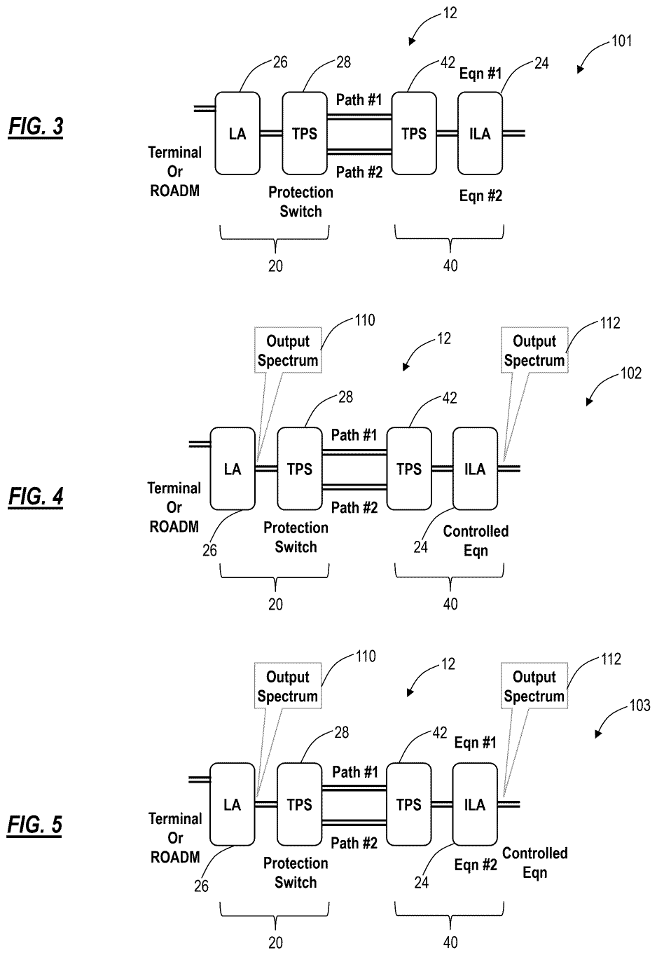

Depending on the chosen equalization strategy, various methods can be employed: a calibrated system approach (Method 101), a continuously controlled system approach (Method 102), or a hybrid of both techniques (Method 103). FIGS. 3-5 illustrate these different approaches with reference to a terminal node 20 connected to an intermediate line amplifier node 40, i.e., a single span. Those skilled in the art will appreciate, while illustrates between the terminal node 20 and the intermediate line amplifier node 40, the same principles apply between two intermediate line amplifier nodes 40. Also, in these FIGS. 3-5 , traffic flows from left to right, i.e., from the terminal node 20 to the intermediate line amplifier node 40, and there is a switch between paths 1 and 2, i.e., rungs on the ladder, and the switch must be accommodated at the intermediate line amplifier node 40, i.e., spectral equalization.

In all cases (Method 101, 102, 103), a dynamically adjustable spectral equalizer, integrated with an optical amplifier 24, is necessary to reshape the system's spectral profile on-the-fly. This approach necessitates an intermediate line amplifier 24 equipped with advanced equalization capabilities, enabling real-time adjustments to the spectral response of the transmission system. Such devices can be integrated into a flexible and programmable line system, providing the actuation needed to adapt the network's spectral profile as link conditions change. By incorporating a dynamically tunable equalization element, the system can swiftly respond to varying optical path characteristics, ensuring that performance remains near-optimal even after protection switches or other network events. By actively adapting to changing conditions, the network 12 can ensure that each path switch yields the least possible performance penalty, maintaining higher overall capacity and service quality despite the inherent complexities and nonlinearities of multi-span fiber routes.

Within the optical amplifier 24, a dynamically tunable equalization element operates as an intelligent, wavelength-selective filter designed to compensate for frequency-dependent (wavelength-dependent) signal attenuation and gain variations. As optical signals propagate through fibers or other waveguiding media, certain wavelengths may experience greater loss or dispersion than others, resulting in an uneven optical spectrum. By placing the equalization element at the midpoint of the amplification process, the optical amplifier 24 can apply corrective spectral shaping before the output stage, maintaining a consistent and balanced gain profile across all channels. This element often relies on electronically adjustable optical components—such as tunable filters, variable optical attenuators, or the like—that can be adjusted in real-time by an integrated control system monitoring input and output spectra. When the optical amplifier 24 detects changes in environmental conditions, fiber lengths, or channel loading, it dynamically refines the element's parameters to restore gain and spectral balance. Through continuous, adaptive compensation, the dynamically tunable equalization element ensures that the optical amplifier consistently delivers a clean, even output across the entire set of wavelengths it supports.

Note, the present disclosure utilizes this functionality to support dynamic spectral equalization as the ladder protection switches between rungs, i.e., between the paths 1, 2.

### Method 101: Calibrated System Approach

FIG. 3 illustrates a network diagram of the Method 101 for a calibrated system approach in the ladder optical network 12. During the calibration phase of the ladder optical network 12, as illustrated in FIG. 3, the network 12 is operated under a fully loaded spectral condition—using either amplified spontaneous emission (ASE) loading or a full set of signal channels—to determine optimal power profiles. Each ILA 24 along the transmission path leverages its dynamic equalization filter to precisely shape the optical spectrum, thereby achieving an ideal input power profile into the subsequent fiber span. This process establishes a calibrated operating point under known conditions, ensuring that the network's spectral distribution and power levels are finely tuned for maximum performance.

In addition to setting the equalization for the primary operating path, the path 1, the calibration procedure also engages the protection switch for designated segments of the network, i.e., the different rungs. By doing so, it derives and stores multiple sets of equalization functions—one for each potential path 1, 2. In essence, each ILA 24 retains a series of “calibrated” equalization spectra, referred to as eqn-n, corresponding to each alternate route within the network's protection domain, n being the number of possible preceding rungs. These stored configurations are accessible at any time, allowing the network 12 to dynamically restore optimal signal conditions following a disruption.

When a fiber failure occurs, the protection switch activates and reroutes traffic from the primary path (for example, path-1) to an alternate path (path-2), typically completing this switchover in less than 50 milliseconds. Although traffic is quickly restored, the newly selected path may not initially exhibit the correct spectral conditions. To address this, the protection switch signals the downstream ILAs 24 to recall and apply the corresponding stored equalization profile (in this example, shifting from eqn1 to eqn2). While adjusting the equalization may take longer than the immediate protection switch—on the order of several seconds—this subsequent tuning step rapidly and automatically returns the network 12 to its previously calibrated optimal spectral balance. In doing so, the network 12 minimizes downtime and quality degradation, providing a more resilient and robust transmission environment.

### Method 102: Controller System Approach

FIG. 4 illustrates a network diagram of the Method 102 for a controlled system approach in the ladder optical network 12. As illustrated in FIG. 4, the Method 102 employs a more controlled system approach within the ladder optical network 12 to maintain optimal spectral conditions after network reconfiguration events. In this Method 102, the optical spectrum is actively measured on both the upstream and downstream sides of the protection segment—specifically at the output of the head-end amplifier (before the protection section) and the tail-end amplifier (after the protection section), as noted by callout for optical spectrum 110, 112. For example, the optical spectrum can be measured using an optical channel monitor which can take a small portion of the optical signal via a tap to a photodetector for monitoring thereof. By “bookending” the protection section in this manner, the system can establish accurate reference points at well-defined, high-power locations where measurement precision is improved. Using these spectral measurements, the required equalization shape for the downstream ILA 24 is calculated in real-time, enabling dynamic, data-driven adjustment of the gain profile.

Following a fiber failure, a protection switch rapidly reroutes traffic—often in under 50 milliseconds—to an alternate path (for example, from path-1 to path-2) to restore service continuity as quickly as possible. Although this immediate action ensures minimal traffic disruption, the new path may differ from the pre-failure conditions, causing a temporary mismatch in the equalization profile. To address this, the protection switch signals the downstream ILA 24 to update its spectral response. The system then takes fresh measurements of the altered transmission characteristics, recalculates the optimal gain profile, and gradually tunes the equalization to return the network 12 to a calibrated, stable state. While this readjustment process takes longer than the initial protection switch—potentially several seconds or more—it ensures that the final equalization reflects current network conditions rather than relying solely on previously stored calibrations.

One key advantage of this controlled approach is its ability to accommodate evolving network circumstances. Because it continuously or periodically measures the transmitted spectrum, this Method 102 accounts for any shifts in spectral performance that may have occurred since the initial calibration phase. However, achieving stable and reliable performance often requires implementing the process in a damped, measured manner. By refining the equalization shape at a controlled pace—rather than making abrupt changes—the network ensures that each incremental adjustment leads toward the optimal spectrum without introducing excessive oscillations or instability. As a result, the controlled system approach delivers a more adaptive, precise, and resilient method for maintaining top-quality optical transmission in the face of network changes.

### Method 3: Hybrid Calibration and Control Approach

FIG. 5 illustrates a network diagram of the Method 103 for a hybrid calibration and control approach in the ladder optical network 12. As illustrated in FIG. 5, the Method 103 employs a hybrid approach that combines both pre-established calibration and ongoing control mechanisms to maintain optimal spectral conditions within the ladder optical network 12. Similar to the fully controlled approach, this Method 103 involves measuring the optical spectrum at both the head-end amplifier output (before the protection section) and the tail-end amplifier output (after the protection section), points 110, 112. By using these strategic measurement points—chosen for their strong, well-defined signal levels—the system can accurately assess the current transmission environment across the entire protection section.

When a fiber failure occurs, the protection switch quickly reroutes traffic onto a new path, often completing the switch in under 50 milliseconds. This immediate response ensures minimal service disruption; however, it may result in a spectral mismatch that requires equalization adjustments. To address this challenge, the hybrid method leverages both a stored calibration profile and dynamic control. Initially, the protection switch signals the downstream equalizing ILA 24 to apply the pre-calibrated spectral difference—essentially the known adjustment between eqn1 and eqn2—directly to the equalizer. This instantaneously provides a “jump start” toward the correct spectral shape, allowing the network to rapidly approach near-optimal conditions without waiting for a fully iterative tuning process.

Once this pre-calibrated correction is in place, a controller then refines the spectral profile by continuously or periodically measuring the actual transmitted spectrum and making incremental adjustments as needed. This controlled fine-tuning step addresses any residual discrepancies, ultimately guiding the equalization back to a perfectly calibrated state. By merging calibration-based quick adjustments with ongoing measurement-driven corrections, the hybrid Method 103 offers the best of both worlds: the rapid restoration of a pre-known spectral condition combined with the flexibility and precision of a fully controlled, real-time equalization process. As a result, this approach can significantly reduce the time to reach optimal performance after a protection switch event while still accommodating variations in the network's operating conditions.

### Dynamic Equalization Method

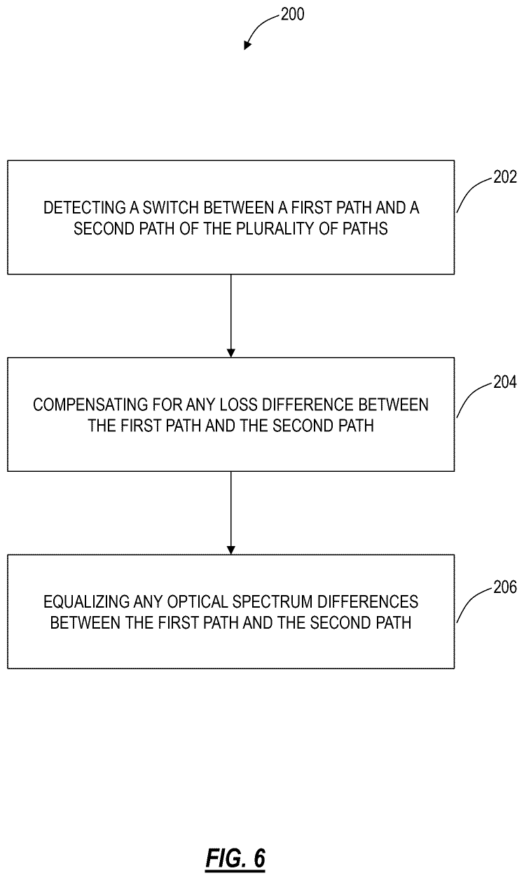

FIG. 6 illustrates a flowchart of a dynamic equalization method 200 in the ladder optical network 12. The dynamic equalization method 200 contemplates implementation as a method having steps, via an apparatus with circuitry configured to implement the steps, and as a non-transitory computer-readable medium storing instructions that, when executed, cause circuitry to implement the steps. In particular, the dynamic equalization method 200 is performed in the ladder optical network 12 at a downstream ILA 24. For example, in FIGS. 3-5, the downstream ILA 24 is shown adjacent to the terminal node 20. Those skilled in the art will recognize the downstream ILA 24 could also be adjacent to an upstream ILA 24.

The dynamic equalization method 200 provides a mechanism for rapid and automatic adjustment of the optical spectrum at the downstream ILA 24 following a fiber protection switch event. By synchronizing the spectral equalization process with the protection switch itself, the dynamic equalization method 200 can restore optimal transmission conditions in a fraction of the time it would otherwise take. This prompt spectral correction ensures that the link budget margin—essentially the safety buffer for maintaining signal integrity—is quickly recovered, reducing the likelihood that the network 12 will be adversely affected if another protection event is triggered soon after.

Because the link budget no longer needs to accommodate the cumulative spectral imbalances of multiple, simultaneous protection sections, in other downstream spans from the downstream ILA 24, the network's 12 maximum capacity can be maintained without compromising performance. In other words, only one protection section's impact needs to be accounted for at a time, allowing many more protection sections to be cascaded along the path without diminishing the overall network 12 throughput. To achieve this high-speed, stable switching, the dynamic equalization method 200 relies on loss-balancing protection switches, which provide the initial, coarse gain compensation required to prevent harmful optical transients. Building on this stable baseline, the system then employs programmable equalizing line amplifiers 24 to deliver a fine-tuned, wavelength-by-wavelength response, ensuring that the optical spectrum remains balanced, optimized, and ready for whatever conditions the network 12 may encounter.

The dynamic equalization method 200 is implemented in a downstream intermediate line amplifier (ILA) node 40 with an ILA 24 and a trunk protection switch (TPS) 42 connected to a plurality of paths, (e.g., paths 1, 2), each forming a rung in a ladder protection scheme. The dynamic equalization method 200 includes detecting a switch between a first path and a second path of the plurality of paths (step 202); compensating for any loss difference between the first path and the second path (step 204); and equalizing any optical spectrum differences between the first path and the second path (step 206).

While steps 202, 204, 206 are shown in sequential order, depending upon the configuration of the equipment, the path losses can be balanced (the compensating step 204) before the detection of a failure event and then when the failure occurs, only the spectral adjustment is needed (the equalizing step 206). This can be achieved by having the loss balancing VOAs “inside” the protection section. In this way, the loss on the standby path can be matched to the loss on the working path even prior to the failure event. This can be achieved by associating one VOA with each fiber path (e.g. in the TPS) rather than associating this VOA function with the ILA. That is, the step 204 can be performed prior to the step 202 in some embodiments and the order in FIG. 6 is not necessarily required as the steps contemplate operation in various sequences.

In an embodiment, the compensating step 204 is via a variable optical attenuator (VOA) or the TPS. The equalizing step 206 is via an adjustable spectral equalizer at the ILA. In an embodiment, the equalizing is performed by switching settings of the adjustable spectral equalizer from settings for the first path to settings for the second path, such that the ILA is pre-calibrated with the settings for both the first path and the second path. In another embodiment, the equalizing is performed by monitoring a first output at a head-end amplifier adjacent to the ILA on a fiber span and monitoring a second output power, and adjusting the adjustable spectral equalizer based on the first output and the second output to equalize residual errors from the switching settings. The equalization of any optical spectrum differences is synchronized with the switch, causing the equalization before a second failure in the ladder protection scheme. By synchronized, the equalization is caused responsive to the switch. Note, a typically protection switch occurs in less than 50 milliseconds and the equalization begins based on that switch. Further, the equalization starts to improve the spectrum and typically lasts on the order of a few seconds. Advantageously, this approach ensures that a second or more failure in the ladder protection scheme has adequate link budget margin.

In a further embodiment, the equalizing is performed by switching settings of the adjustable spectral equalizer from settings for the first path to settings for the second path, such that the ILA is pre-calibrated with the settings for both the first path and the second path; monitoring a first output at a head-end amplifier adjacent to the ILA on a fiber span and monitoring a second output power, and adjusting the adjustable spectral equalizer based on the first output and the second output to equalize residual errors from the switching settings.

### Processing Circuitry and Non-transitory Computer-readable Mediums

Those skilled in the art will recognize that the various embodiments may include processing circuitry of various types. The processing circuitry might include, but are not limited to, general-purpose microprocessors; Central Processing Units (CPUs); Digital Signal Processors (DSPs); specialized processors such as Network Processors (NPs) or Network Processing Units (NPUs), Graphics Processing Units (GPUs); Field Programmable Gate Arrays (FPGAs); Programmable Logic Device (PLD), or similar devices. The processing circuitry may operate under the control of unique program instructions stored in their memory (software and/or firmware) to execute, in combination with certain non-processor circuits, either a portion or the entirety of the functionalities described for the methods and/or systems herein. Alternatively, these functions might be executed by a state machine devoid of stored program instructions, or through one or more Application-Specific Integrated Circuits (ASICs), where each function or a combination of functions is realized through dedicated logic or circuit designs. Naturally, a hybrid approach combining these methodologies may be employed. For certain disclosed embodiments, a hardware device, such as a controller, possibly integrated with software, firmware, or both, might be denominated as circuitry, logic, or circuits “configured to” or “adapted to” execute a series of operations, steps, methods, processes, algorithms, functions, or techniques as described herein for various implementations.

Additionally, some embodiments may incorporate a non-transitory computer-readable storage medium that stores computer-readable instructions for programming any combination of a computer, server, appliance, device, module, processor, controller, or circuit (collectively “system”), each equipped with processing circuitry. These instructions, when executed, enable the system to perform the functions as delineated and claimed in this document. Such non-transitory computer-readable storage mediums can include, but are not limited to, hard disks, optical storage devices, magnetic storage devices, Read-Only Memory (ROM), Programmable Read-Only Memory (PROM), Erasable Programmable Read-Only Memory (EPROM), Electrically Erasable Programmable Read-Only Memory (EEPROM), Flash memory, etc. The software, once stored on these mediums, includes executable instructions that, upon execution by one or more processors or any programmable circuitry, instruct the processor or circuitry to undertake a series of operations, steps, methods, processes, algorithms, functions, or techniques as detailed herein for the various embodiments.

### Conclusion

In this disclosure, including the claims, the phrases “at least one of” or “one or more of” when referring to a list of items mean any combination of those items, including any single item. For example, the expressions “at least one of A, B, or C,” “at least one of A, B, and C,” “one or more of A, B, or C,” and “one or more of A, B, and C” cover the possibilities of: only A, only B, only C, a combination of A and B, A and C, B and C, and the combination of A, B, and C. This can include more or fewer elements than just A, B, and C. Additionally, the terms “comprise,” “comprises,” “comprising,” “include,” “includes,” and “including” are intended to be open-ended and non-limiting. These terms specify essential elements or steps but do not exclude additional elements or steps, even when a claim or series of claims includes more than one of these terms.

Although operations, steps, instructions, blocks, and similar elements (collectively referred to as “steps”) are shown or described in the drawings, descriptions, and claims in a specific order, this does not imply they must be performed in that sequence unless explicitly stated. It also does not imply that all depicted operations are necessary to achieve desirable results. In the drawings, descriptions, and claims, extra steps can occur before, after, simultaneously with, or between any of the illustrated, described, or claimed steps. Multitasking, parallel processing, and other types of concurrent processing are also contemplated. Furthermore, the separation of system components or steps described should not be interpreted as mandatory for all implementations; also, components, steps, elements, etc. can be integrated into a single implementation or distributed across multiple implementations.

While this disclosure has been detailed and illustrated through specific embodiments and examples, it should be understood by those skilled in the art that numerous variations and modifications can perform equivalent functions or achieve comparable results. Such alternative embodiments and variations, even if not explicitly mentioned but that achieve the objectives and adhere to the principles disclosed herein, fall within the spirit and scope of this disclosure. Accordingly, they are envisioned and encompassed by this disclosure and are intended to be protected under the associated claims. In other words, the present disclosure anticipates combinations and permutations of the described elements, operations, steps, methods, processes, algorithms, functions, techniques, modules, circuits, and so on, in any conceivable order or manner—whether collectively, in subsets, or individually—thereby broadening the range of potential embodiments.

What is claimed is:

1. A downstream intermediate line amplifier (ILA) node comprising:
an ILA and a trunk protection switch (TPS) connected to a plurality of paths, each forming a rung in a ladder protection scheme; and
a controller configured to
detect a switch between a first path and a second path of the plurality of paths,
cause compensation for any loss difference between the first path and the second path, and
cause equalization of any optical spectrum differences between the first path and the second path.

2. The downstream ILA of claim 1, wherein the compensation is via a variable optical attenuator (VOA) or the TPS.

3. The downstream ILA of claim 1, wherein the equalization is via an adjustable spectral equalizer at the ILA.

4. The downstream ILA of claim 3, wherein the equalization is performed by switching settings of the adjustable spectral equalizer from settings for the first path to settings for the second path, such that the ILA is pre-calibrated with the settings for both the first path and the second path.

5. The downstream ILA of claim 3, wherein the equalization is performed by
monitoring a first output at a head-end amplifier adjacent to the ILA on a fiber span and monitoring a second output power, and
adjusting the adjustable spectral equalizer based on the first output and the second output.

6. The downstream ILA of claim 3, wherein the equalization is performed by
switching settings of the adjustable spectral equalizer from settings for the first path to settings for the second path, such that the ILA is pre-calibrated with the settings for both the first path and the second path,
monitoring a first output at a head-end amplifier adjacent to the ILA on a fiber span and monitoring a second output power, and
adjusting the adjustable spectral equalizer based on the first output and the second output to equalize residual errors from the switching settings.

7. The downstream ILA of claim 1, wherein the ladder protection scheme includes the plurality of paths providing fiber diversity without equipment protection.

8. The downstream ILA of claim 1, wherein the equalization of any optical spectrum differences is synchronized with the switch, causing the equalization before a second failure in the ladder protection scheme.

9. A dynamic equalization method implemented in a downstream intermediate line amplifier (ILA) node comprising an ILA and a trunk protection switch (TPS) connected to a plurality of paths, each forming a rung in a ladder protection scheme, the dynamic equalization method comprising steps of:
detecting a switch between a first path and a second path of the plurality of paths;
compensating for any loss difference between the first path and the second path; and
equalizing any optical spectrum differences between the first path and the second path.

10. The dynamic equalization method of claim 9, wherein the compensating is via a variable optical attenuator (VOA) or the TPS.

11. The dynamic equalization method of claim 9, wherein the equalizing is via an adjustable spectral equalizer at the ILA.

12. The dynamic equalization method of claim 11, wherein the equalizing is performed by switching settings of the adjustable spectral equalizer from settings for the first path to settings for the second path, such that the ILA is pre-calibrated with the settings for both the first path and the second path.

13. The dynamic equalization method of claim 11, wherein the equalizing is performed by
monitoring a first output at a head-end amplifier adjacent to the ILA on a fiber span and monitoring a second output power, and
adjusting the adjustable spectral equalizer based on the first output and the second output.

14. The dynamic equalization method of claim 11, wherein the equalizing is performed by
switching settings of the adjustable spectral equalizer from settings for the first path to settings for the second path, such that the ILA is pre-calibrated with the settings for both the first path and the second path;
monitoring a first output at a head-end amplifier adjacent to the ILA on a fiber span and monitoring a second output power, and
adjusting the adjustable spectral equalizer based on the first output and the second output to equalize residual errors from the switching settings.

15. The dynamic equalization method of claim 9, wherein the ladder protection scheme includes the plurality of paths providing fiber diversity without equipment protection.

16. A ladder optical network comprising:
a first terminal node and a second terminal node;
one or more intermediate line amplifier (ILA) nodes interconnecting the first terminal node and the second terminal node, using a ladder protection scheme,
wherein each of the one or more ILA nodes includes an ILA and two protection switches (TPSs) on either side of the ILA, each TPS of the TPSs connect connected to a plurality of paths, each forming a rung in a ladder protection scheme, and
wherein each of the one or more ILA nodes is configured to
detect a switch between a first path and a second path of the plurality of paths,
compensate for any loss difference between the first path and the second path, and equalize any optical spectrum differences between the first path and the second path.

17. The ladder optical network of claim 16, wherein the loss is compensated via a variable optical attenuator (VOA) or the TPS.

18. The ladder optical network of claim 16, wherein the optical spectrum is equalized via an adjustable spectral equalizer at the ILA.

19. The ladder optical network of claim 16, wherein the optical spectrum is equalized by switching settings of the adjustable spectral equalizer from settings for the first path to settings for the second path, such that the ILA is pre-calibrated with the settings for both the first path and the second path.

20. The ladder optical network of claim 16, wherein the optical spectrum is equalized by
monitoring a first output at a head-end amplifier adjacent to the ILA on a fiber span and monitoring a second output power, and
adjusting the adjustable spectral equalizer based on the first output and the second output.
